(19) United States
(12) Patent Application Publication
(10) Pub. No.: US 2015/0151714 A1
(43) Pub. Date: Jun. 4, 2015

(54) VEHICLE CONTROL SYSTEM WITH SUPPRESSION OF WIPER NOISE

(71) Applicant: Masachika Kamiya, Toyota-shi (JP)

(72) Inventor: Masachika Kamiya, Toyota-shi (JP)

(73) Assignee: TOYOTA JIDOSHA KABUSHIKI KAISHA, Toyota-shi, Aichi-ken (JP)

(21) Appl. No.: 14/406,692

(22) PCT Filed: Jun. 7, 2013
(86) PCT No.: PCT/IB2013/001183

§ 371 Date: Dec. 9, 2014

(30) Foreign Application Priority Data
Jun. 12, 2012 (JP) 2012-133244

(51) Int. Cl. B60S 1/08

(52) U.S. Cl. CPC B60S 1/08

(57) ABSTRACT

A vehicle control system includes a wiper, a control portion that outputs a drive command such that the wiper is placed in a first state or a second state that is more restricted than the first state, and a checking portion that checks whether a mobile device is in the vehicle via wireless communication between an onboard device and the mobile device, when a door of the vehicle is opened or closed. If the door is opened while the wiper is in the first state, the control portion performs a first control that switches the operating state of the wiper from the first state to the second state, and then after a period of time for which the check by the checking portion is executed has passed while the wiper is in the second state, the control portion switches the operating state from the second state to the first state.

### BACKGROUND OF THE INVENTION

1. Field of the Invention

The invention relates to a vehicle control system. More particularly, the invention relates to a vehicle control system mounted in a vehicle, which is provided with a wiper, an operating state of which is selectively switched between a first operating state and a second operating state that is more restricted than the first operating state, a wiper control portion that outputs a drive command for the wiper, and a checking portion that checks whether a mobile device carried by a user of a vehicle is in a vehicle cabin (hereinafter also simply referred to as “in the vehicle”) via wireless communication between an onboard device and the mobile device is in the vehicle, when a vehicle door is opened or closed.

2. Description of Related Art

A vehicle control system that allows an engine to start or locks/unlocks a vehicle door via wireless communication between an onboard device and a mobile device carried by a user of a vehicle is known (see Japanese Patent Application Publication No. 2006-104663 (JP 2006-104663 A), for example). In this vehicle control system, in order to prevent the mobile device from being taken out of the vehicle, a vehicle interior check to check whether the mobile device is in the vehicle is performed via wireless communication between the onboard device and the mobile device when a vehicle door is opened or closed.

The vehicle interior check via wireless communication between the onboard device and the mobile device may be impeded by electromagnetic noise generated by a power harness or onboard electrical equipment. If this happens, the vehicle interior check will not be able to be performed properly, and as a result, it may be erroneously determined that the mobile device is not in the vehicle when in fact the mobile device is actually in the vehicle, and an alarm may consequently be issued.

Therefore, in order to avoid this happening, in the vehicle control system described above, when electromagnetic noise of a predetermined level or higher is detected, an alarm is issued to notify a vehicle occupant that this noise has been detected.

However, with the vehicle control system according to JP 2006-104663 A described above, only an alarm is issued when noise from onboard electrical equipment or the like, is detected, so wireless communication between the onboard device and the mobile device (i.e., the vehicle interior check) may continue to be impeded by this noise. Therefore, it is difficult to properly perform a vehicle interior check when a vehicle door is opened or closed.

One example of onboard electrical equipment is a wiper, the operating state of which is switched among three states, i.e., a continuous operating state, an intermittent operating state, and a stopped state. A motor that drives the wiper is the source that generates noise. That is, when the wiper is in the continuous operating state, noise that accompanies this operation is constantly generated by the motor. Therefore, if the mobile device is close to the noise generating source, wireless communication between the onboard device and the mobile device will always be impeded. As a result, it is difficult to properly perform a vehicle interior check that is performed when a vehicle door is opened or closed. Also, when the wiper is in the intermittent operating state, noise that accompanies the operation of the motor is generated every predetermined period of time, so periods of time during which wireless communication between the onboard device and the mobile device is impeded are mixed with periods of time during which this wireless communication is not impeded. Therefore, even if the mobile device is close to the noise generating source, there will be times when the vehicle interior check is able to be properly performed. On the other hand, when the wiper is in the stopped state, noise that accompanies operation of the motor is not generated, so the vehicle interior check is able to be properly performed.

### SUMMARY OF THE INVENTION

In view of the foregoing points, the invention proposes a vehicle control system capable of inhibiting a vehicle interior check, which is performed when a vehicle door is opened or closed, from being impeded as a result of operation of a wiper.

One aspect of the invention relates to a vehicle control system that includes a wiper, an operating state of which is selectively switched between a first operating state and a second operating state that is more restricted than the first operating state; a wiper control portion that outputs a drive command such that the wiper is placed in the first operating state or the second operating state; and a checking portion that checks whether a mobile device carried by a user of a vehicle is in the vehicle via wireless communication between an onboard device and the mobile device, when a door of the vehicle is opened or closed. If the door is opened while the wiper is in the first operating state, the wiper control portion performs a first switching control that switches the operating state of the wiper from the first operating state to the second operating state, and then after a period of time for which the check by the checking portion is executed has passed while the wiper is in the second operating state switched by the first switching control, performs a second switching control that switches the operating state of the wiper from the second operating state to the first operating state.

The invention thus makes it possible to inhibit a vehicle interior check, which is performed when a vehicle door is opened or closed, from being impeded as a result of operation of a wiper.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a vehicle control system according to an example embodiment of the invention;

FIG. 2 view illustrating a state in which a vehicle interior check is performed when a wiper is operating continuously;

FIG. 3 is a flowchart illustrating one example of a control routine executed in the vehicle control system of the example embodiment; and

FIG. 4 is a view illustrating a state in which the vehicle interior check is performed after the operating state of the wiper has changed from a continuous operating state to an intermittent operating state.

### DETAILED DESCRIPTION OF EMBODIMENTS

Hereinafter, specific example embodiments of the vehicle control system according to the invention will be described with reference to the accompanying drawings.

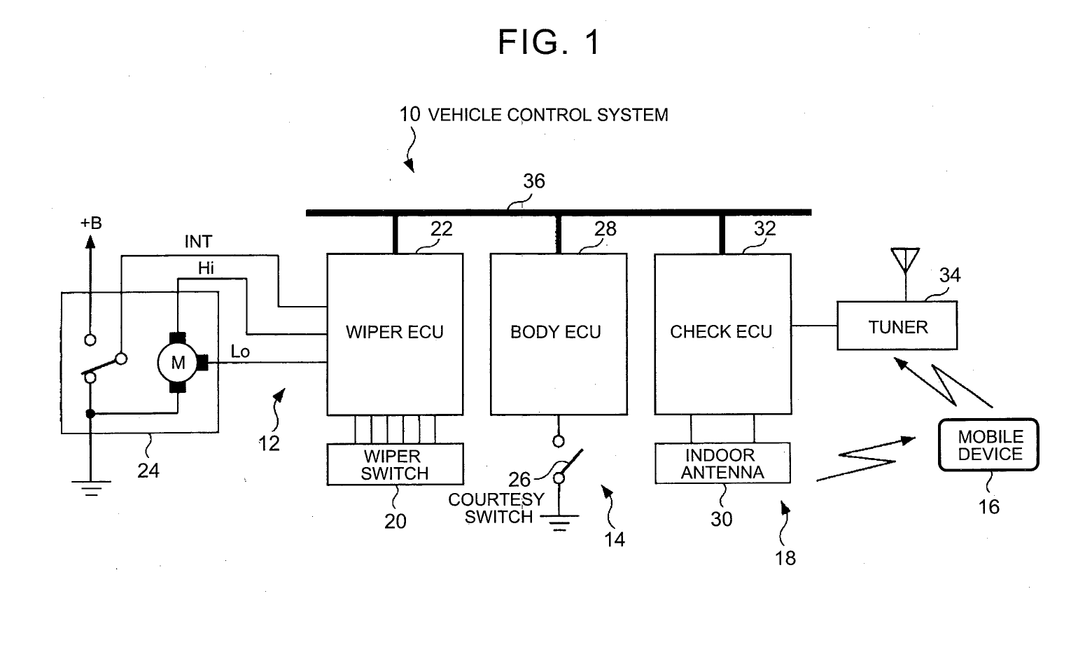

FIG. 1 is a block diagram of a vehicle control system 10 according to one example embodiment of the invention. The vehicle control system 10 of this example embodiment is a control system that is mounted in a vehicle, and has the structure described below. That is, the vehicle control system 10 includes a wiper control device 12 that controls the operation of a wiper that wipes an outside surface of a front windshield or a rear window, a body control device 14 that detects both the opening and closing of a vehicle door, and a checking device 18 that wirelessly communicates with a mobile device 16, as shown in FIG. 1.

The wiper control device 12 has a wiper control switch 20 that can be operated by a driver of the vehicle, a wiper electronic control unit (hereinafter, simply referred to as “wiper ECU”) 22 that performs an operating process of the wiper, and a wiper motor 24 that operates the wiper. The wiper control device 12 may be a rain sensing type that is able to control wiper operation automatically according to the amount of rain and the vehicle speed, or it may be an intermittent time-adjust type in which the frequency of the intermittent operation of the wiper is able to be controlled by the driver.

The wiper control switch 20 is an operating switch for switching the wiper among various states, i.e., an OFF state in which operation of the wiper is stopped, an AUTO state in which the wiper is operated automatically or an INT state in which the wiper is operated intermittently, a LO state in which the wiper is operated continuously at a low speed, and a HI state in which the wiper is operated continuously at a high speed. The wiper ECU 22 is connected to this wiper control switch 20. Wiper operation command information indicated by the wiper control switch 20 is supplied to the wiper ECU 22.

The wiper ECU 22 mainly includes a CPU that performs an operating process, RAM that provides a work area for the CPU, and ROM in which programs and data are stored. The wiper ECU 22 specifies the operating state to be realized by the wiper that is required by the driver of the vehicle, based on the operation command information from the wiper control switch 20. The wiper ECU 22 may also drive the wiper also using information from a rain sensor and information related to the vehicle speed. More specifically, the wiper ECU 22 may specify the optimum operating state to be realized by the wiper, from an intermittent operating state of intermittent pauses of a predetermined length of time (e.g., 15 seconds at most) to the high speed continuous operating state, based on the amount of rain detected using the rain sensor and the vehicle speed detected using a vehicle speed sensor, when the wiper control switch 20 is in the position corresponding to the AUTO state. This optimum operating state may be set, for example, to an intermittent operating state in which .the intermittent pause time is longer when the amount of rain is smaller or the vehicle speed is lower, or it may be set to a continuous operating state of a higher speed when the amount of rain is greater or the vehicle speed is higher.

The continuous operating state described above is a state in which the wiper is continuously operated, with almost no time during which wiper operation is stopped (i.e., with almost no operation-stopped time or intermittent pause time). Also, the intermittent operating state described above is a state in which there are periods of time during which operation of the wiper stops (i.e., operation-stopped time or intermittent pause time), and the wiper operates intermittently at predetermined intervals of time. That is, the intermittent operating state is a state in which operation of the wiper is more restricted than it is in the continuous operating state.

The wiper motor 24 is connected to the wiper ECU 22. In principle, when the operating state to be realized by the wiper is specified as described above, the wiper ECU 22 outputs a drive command to the wiper motor 24 so that the operating state of the wiper matches the specified operating state. The wiper motor 24 is an electric motor for operating a front wiper that wipes the outside surface of a front windshield, or a rear wiper that wipes the outside surface of a rear window, either of which may serve as the wiper. The wiper motor 24 operates the wiper according to the drive command from the wiper ECU 22.

Also, the body control device 14 includes a courtesy switch 26 that turns on or off according to the state of a door of the vehicle, i.e., whether a door of the vehicle is open or closed, and a body electronic control unit (hereinafter, simply referred to as “body ECU”) 28 that detects the state (i.e., an open state and a closed state) of a door of the vehicle. The courtesy switch 26 is a switch that turns off when a door of the vehicle is open (e.g., particularly a front door next to the driver seat or the front passenger seat), and turns on when the vehicle door is closed. Information relating to the open state or the closed state of the door of the vehicle indicated by the courtesy switch 26 is supplied to the body ECU 28.

The body ECU 28 mainly includes a CPU that performs an operating process, RAM that provides a work area for the CPU, and ROM in which programs and data are stored. The body ECU 28 detects the open state and the closed state of the door of the vehicle described above based on the information relating to the open state or the closed state of the door from the courtesy switch 26.

Furthermore, the mobile device 16 is a mobile key that is carried by a user of the vehicle. This key is an electronic key used with a corresponding vehicle. The mobile device 16 has a communication function for wirelessly communicating with the checking device 18, and is able to send and receive signals of a predetermined frequency (such as in a LF band, e.g., a 125 kHz band or a 134 kHz band, or in a RF band, e.g., a 300 MHz band or a 400 MHz band) to and from the checking device 18. Various devices mounted in the vehicle each display a function based on the check results from the wireless communication between the mobile device 16 and the checking device 18. For example, the devices may display a function for unlocking a vehicle door, a function for locking a vehicle door, a function for changing a power supplying state to onboard equipment according to a combination of an ignition switch operation and a brake pedal operation, and a function for determining whether the mobile device 16 has been taken out of the vehicle, and the like.

The checking device 18 has an indoor antenna 30 provided in the vehicle cabin, a check electronic control unit (hereinafter, simply referred to as a “check ECU”) 32 that checks a code obtained via wireless communication with the mobile device 16, and an indoor tuner 34 that receives signals from the mobile device 16. The check ECU 32 generates a request signal to request a response from the mobile device 16, and sends this request signal from a suitable transmitting antenna. When the state of the door of the vehicle changes from an open state to a closed state, the check ECU 32 sends a request signal from the indoor antenna 30 and creates a detection area for detecting the mobile device 16 in the vehicle cabin in order to realize the vehicle interior check function to determine whether the mobile device 16 is in the vehicle, i.e., whether the mobile device 16 has been taken out of the vehicle.

The mobile device 16 is able to receive the request signal sent from the checking device 18 that is an onboard device. Upon receiving the request signal from the checking device 18, the mobile device 16 sends a response signal in response to this request signal. The checking device 18 is able to receive the response signal sent from the mobile device 16. The response signal from the mobile device 16 that is received by the checking device 18 is supplied to the check ECU 32.

After a request signal has been transmitted from a transmitting antenna, when the check ECU 32 receives the response signal in response to this request signal transmitted from the mobile device 16, the check ECU 32 then checks an ID code obtained by demodulating this response signal against a predetermined ID code stored in the memory of the check ECU 32 itself beforehand. The check ECU 32 then drives the onboard device corresponding to the displayed function based on this check result.

The checking device 18 is able to receive the response signal from the mobile device 16 using the indoor tuner 34 provided in the vehicle cabin. The check ECU 32 is connected to the indoor tuner 34. The response signal from the mobile device 16 that is received by the indoor tuner 34 is supplied to the check ECU 32. After a request signal has been sent from the indoor antenna 30, the check ECU 32 determines whether a response signal sent from the mobile device 16 in response to this request signal has been received by the indoor tuner 34. If it is determined that this response signal has been received by the indoor tuner 34, the check ECU 32 checks an ID code obtained by demodulating this response signal with a predetermined ID code stored in memory beforehand.

As a result, if it is determined that the response signal has not been received by the indoor tuner 34, or if it is determined that the response signal has been received by the indoor tuner 34 but the ID code does not match, then it is determined that the authorized mobile device 16 is not in the vehicle cabin, and an alarm is issued by sounding a buzzer or the like, for example. On the other hand, if the response signal is received by the indoor tuner 34 and the ID code matches, it is determined that the authorized mobile device 16 is in the vehicle cabin, so an alarm is not issued.

The wiper ECU 22, the body ECU 28, and the check ECU 32 are all connected together via an onboard LAN 36. ECUs other than those described above may also be connected to the onboard LAN 36. The onboard LAN 36 may be a CAN (Controller Area Network) or the like, for example. The ECUs that are connected together via the onboard LAN 36 are able to send and receive data to and from each other via the onboard LAN 36.

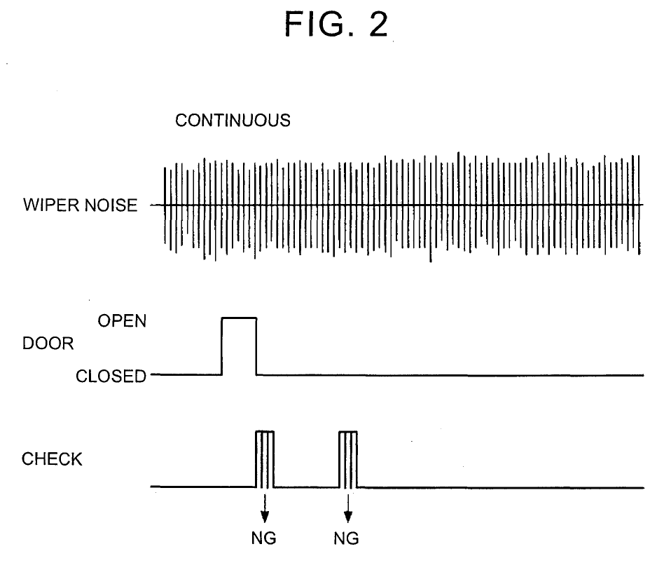

Hereinafter, the characteristic operation of the vehicle control system 10 of this example embodiment will be described with reference to FIGS. 2 to 4.

FIG. 2 is a view illustrating a state in which a vehicle interior check is performed when a wiper is operating continuously. In this example embodiment, when the wiper control switch 20 is in the LO state in which the wiper continuously operates at a low speed, or the HI state in which the wiper continuously operates at a high speed, or when the wiper control switch 20 is in the AUTO state in which the wiper operates automatically and the optimum operating state to be realized by the wiper is set to a continuous operating state based on the amount of rain and the vehicle speed, the wiper is operated continuously, without intermittent pauses, by the wiper motor 24 being driven by a drive command from the wiper ECU 22.

When the wiper is continuously operated by driving the wiper motor 24, operating noise is generated with this driving of the wiper motor 24. This operating noise is constantly generated by the continuous driving of the wiper motor 24. If the mobile device 16 is close to the wiper motor 24 that is the noise generating source, such as when the mobile device 16 is placed on the instrument panel or the like, it is highly likely that wireless communication in the vehicle cabin between the checking device 18 and the mobile device 16, i.e., a request signal in the LF band sent from the indoor antenna 30 of the checking device 18, or a response signal in the LF band sent from the mobile device 16 in the vehicle, will constantly be impeded. Therefore, in this case, it is difficult to properly perform a vehicle interior check (see FIG. 2).

Therefore, the vehicle control system 10 of this example embodiment inhibits a vehicle interior check via wireless communication in the vehicle cabin between the onboard device and the mobile device from being impeded by the continuous operation of the wiper. The characteristic portion of this will be described below.

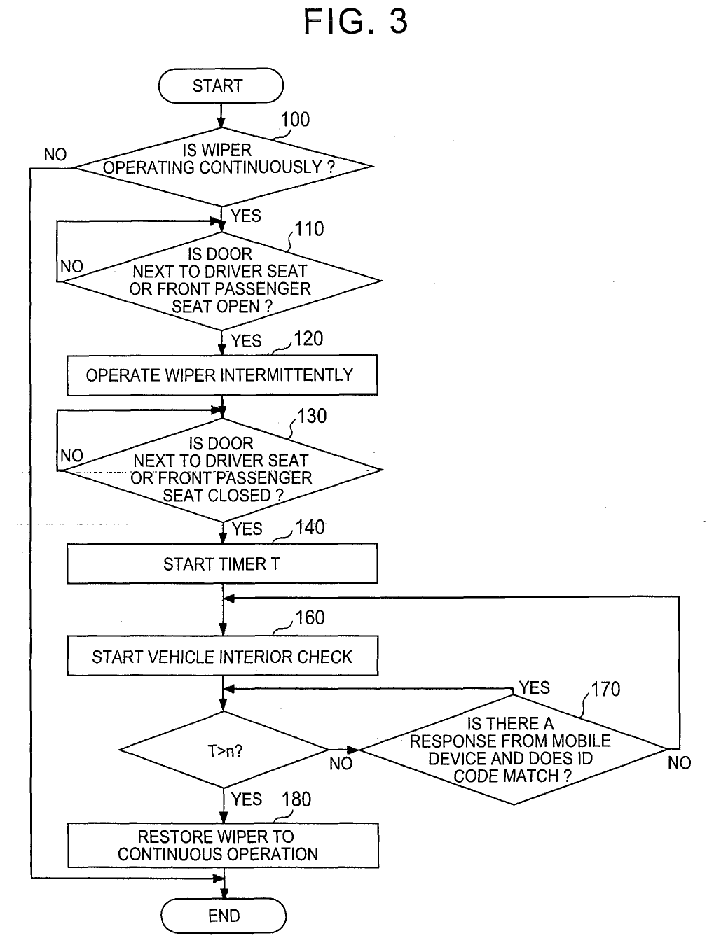

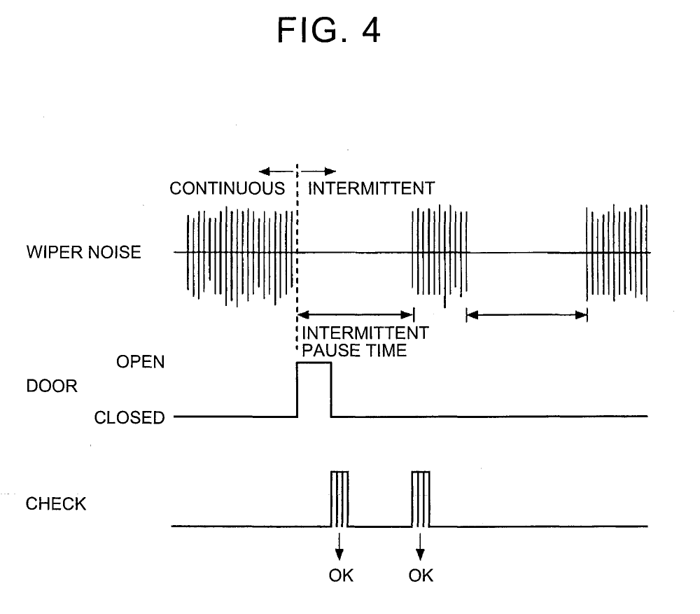

FIG. 3 is a flowchart illustrating one example of a control routine executed in the vehicle control system 10 of this example embodiment. Also, FIG. 4 is a view illustrating a state in which the vehicle interior check is performed after the operating state of the wiper has changed from a continuous operating state to an intermittent operating state.

In this example embodiment, when the power is on, the wiper ECU 22 of the wiper control device 12 specifies an operating state to be realized by the wiper that is required by the driver of the vehicle, based on the operating command information from the wiper control switch 20, and outputs a drive command to the wiper motor 24 so that the specified operating state is realized. When the power is on, the wiper ECU 22 determines whether a drive command to place the wiper in a continuous operating state regardless of the speed (i.e., low speed or high speed) is being output to the wiper motor 24 (step 100). If the result is such that it is determined that the wiper is in a continuous operating state, the wiper ECU 22 ends this cycle of the routine without proceeding on to any other steps.

Also, when the power is on, the body ECU 28 of the body control device 14 determines whether a door of the vehicle (e.g., particularly a front door next to the driver seat or the front passenger seat) is open or closed based on information from the courtesy switch 26, and sends the information related to this determination result to the onboard LAN 36. When the power is on, the wiper ECU 22 and the check ECU 32 of the checking device 18 receive that data relating to the state of the door, i.e., whether the door is open or closed, from the body ECU 28 via the onboard LAN 36.

If it is determined in step 100 that the wiper is in the continuous operating state, the wiper ECU 22 then determines whether a door of the vehicle is open, or specifically, whether the door has changed from a closed state to an open state (i.e., whether the door has changed from being closed to being open), based on the information from the body ECU 28 received via the onboard LAN 36 (step 110). This determination is made repeatedly until the determination is yes.

When it is determined that door has changed from a closed state to an open state, the wiper ECU 22 then executes a process to forcibly place the wiper in the intermittent operating state (step 120). More specifically, the wiper ECU 22 outputs a drive command to the wiper motor 24 so that the wiper will be placed in the intermittent operating state. This forced intermittent operating state of the wiper may be a state having a predetermined intermittent pause time (such as approximately 1.5 seconds, for example) that is set beforehand.

After the wiper has been forcibly placed in the intermittent operating state due to the door of the vehicle changing from being closed (i.e., the closed state) to being open (i.e., the open state) as described above, the check ECU 32 determines whether the door of the vehicle is open based on information relating to the open state or the closed state of the door from the body ECU 28 received via the onboard LAN 36. More specifically, the check ECU 32 determines whether the door of the vehicle has changed from being open to being closed (step 130). This determination is made repeatedly until the determination is yes.

Then when is has been determined that the door of the vehicle has changed from being open to being closed, the check ECU 32 starts to time a timer T (step 140). Then, the check ECU 32 starts the vehicle interior check via wireless communication with the mobile device 16 (step 150). The check ECU 32 counts the time after the change in the state of the vehicle door from open to closed, using the timer T. Also, the check for the mobile device 16 in the vehicle is performed by a request signal being sent from the indoor antenna 30 of the checking device 18, and checking the ID code of the response signal from the mobile device 16 received by the indoor tuner 34.

Next, the check ECU 32 determines whether the timer T has reached a predetermined time t (step 160). This predetermined time t is a predetermined length of time, and may be set to an intermittent pause time of the wiper (such as approximately 1.5 seconds, for example) that has been forcibly placed in the intermittent operating state in step 120, for example.

If the result is such that it is determined that the timer T exceeds the predetermined time t, i.e., that T>t is not satisfied, then the indoor tuner 34 receives the response signal from the mobile device 16 according to the vehicle interior check, and the check ECU 32 determines whether the ID code of this response signal matches the ID code stored in memory (step 170). If the indoor tuner 34 does not receive a response signal from the mobile device 16, or if a response signal is received but the ID code of the received response signal does not match the ID code stored in memory, the process returns to step 150 and the check in the vehicle is executed again. On the other hand, if the indoor tuner 34 receives a response signal from the mobile device 16 and it is determined that the ID code of this received response signal matches the ID code stored in memory, the process returns to step 160 and it is again determined whether T>t is satisfied.

On the other hand, if it is determined in step 160 that the timer T exceeds the predetermined time t, i.e., that T>t is satisfied, then the check ECU 32 executes a process to return the wiper to the continuous operating state (step 180). More specifically, the check ECU 32 outputs a return command to return the wiper that had been forcibly placed in the intermittent operating state to the continuous operating state, to the wiper ECU 22 via the onboard LAN 36.

After executing the process of forcibly placing the wiper in the intermittent operating state in step 120, the wiper ECU 22 continues to keep the wiper in the intermittent operating state until it receives a return command to return the wiper to the continuous operating state from the check ECU 32 via the onboard LAN 36. Then, when the wiper ECU 22 receives the return command to return the wiper to the continuous operating state from the check ECU 32 via the onboard LAN 36, the wiper ECU 22 outputs a drive command to the wiper motor 24 such that the wiper is placed in the continuous operating state according to this return command.

Here, if the wiper is continuously operated when a vehicle door (in particular, a vehicle door next to the driver seat or the front passenger seat that is close to the front windshield, the front surface of which is wiped by the wiper) is opened, it is highly likely that water droplets, rain, or snow or the like that flies off of the windshield, the front surface of which is being wiped by the wiper, will adhere to a person getting out of the vehicle through this open vehicle door. With respect to this, according to the process described above, when a vehicle door is opened while the wiper is continuously operating at a low speed or a high speed without intermittent pauses, the operating state of the wiper is able to be forcibly switched from the continuous operating state to the intermittent operating state that has predetermined intermittent pauses of a predetermined length (i.e., time). Therefore, according to this example embodiment, it is possible to inhibit water droplets, rain, or snow or the like that fly off of the surface of the windshield as a result of the wiper operation from adhering to a person getting out of the vehicle while the wiper is continuously operating.

Further, according to the process described above, after the wiper is forcibly switched to the intermittent operating state, when the vehicle door is closed after being open, the forced intermittent operating state of the wiper can be continued until a predetermined time t has passed after the vehicle door is closed, and the vehicle interior check via wireless communication inside the vehicle cabin between the checking device 18 and the mobile device 16 can be executed during this intermittent operation of the wiper.

When the wiper is intermittently operating, the operating noise generated by the wiper motor 24 that operates the wiper is generated intermittently (i.e., at intervals), so during this intermittent pause, operating noise is not generated by the wiper motor 24. If the vehicle interior check is performed during this intermittent pause when the operating noise is not being generated, wireless communication in the vehicle cabin between the checking device 18 and the mobile device 16 is possible. More specifically, a request signal in the LF band sent from the indoor antenna 30 of the checking device 18, or a response signal in the LF band sent from the mobile device 16 in the vehicle, is able to be properly received by the mobile device 16 or the indoor tuner 34 without being impeded by the operating noise from the wiper motor 24.

According to the vehicle control system 10 of this example embodiment, when a vehicle door is opened while the wiper is operating continuously, after the wiper is forcibly placed in the intermittent operating state, this intermittent operating state of the wiper is continued until the predetermined time t has passed after the vehicle door is closed. Accordingly, by executing a check inside the vehicle that is performed when the vehicle door is closed during an intermittent pause of this intermittent operating state, it is possible to inhibit the vehicle interior check from being impeded as a result of the operation of the wiper. Therefore, according to this example embodiment, it is possible to avoid an alarm (indicating that the mobile device 16 has been taken out of the vehicle) being issued erroneously due to the vehicle interior check being impeded as a result of operation of the wiper.

Also, in this example embodiment, even if the wiper is forcibly placed in the intermittent operating state as described above, the wiper will again be returned to the continuous operating state when the vehicle door is then closed and a predetermined period of time t sufficient for completing wireless communication between the checking device 18 and the mobile device 16 and executing the vehicle interior check has passed. Therefore, according to this example embodiment, regardless of whether the operating state to be realized by the wiper is the continuous operating state, after the wiper has been forcibly changed to the intermittent operating state when a vehicle door is opened, it is possible to avoid this intermittent operating state being continued for an extended period of time unnecessarily.

In the example embodiment described above, the continuous operating state functions as the first operating state in the claims, the intermittent operating state functions as the second operating state in the claims, and the checking device 18 functions as the onboard device in the claims. Also, the check ECU 32 that performs the vehicle interior check to check whether the mobile device 16 is in the vehicle via wireless communication with the mobile device 16 when the vehicle door has been opened or closed functions as the checking portion in the claims. Also, the first switching control in the claims is realized by executing the process in step 120 in the routine shown in FIG. 3. Moreover, the second switching control in the claims is realized by executing the process of returning the wiper to the continuous operating state when the check ECU 32 determines in step 160 that the timer T exceeds the predetermined time t, by having the wiper ECU 22 restore the operating state of the wiper to the continuous operating state from the forced intermittent operating state.

In the example embodiment described above, the vehicle control system 10 includes the wiper ECU 22, the body ECU 28, and the check ECU 32 that are all connected together via the onboard LAN 36. Information and data necessary for various controls is sent and received among the ECUs via the onboard LAN 36, and the routine shown in FIG. 3 is executed appropriately by the ECUs. However, the invention is not limited to this. That is, the routine shown in FIG. 3 may also be executed by a single ECU.

Also, in the example embodiment described above, when a vehicle door is opened while the wiper is in the continuous operating state in which the wiper operates continuously, the operating state of the wiper is switched from this continuous operating state to the intermittent operating state in which the wiper operates intermittently. However, the invention is not limited to this. That is, when a vehicle door is opened while the wiper is in a given first operating state, the operating state of the wiper may be switched from this first operating state to a second operating state in which operation of the wiper is more restricted than it is the first operating state.

For example, when a vehicle door is opened while the wiper is in the continuous operating state in which the wiper operates continuously as described above, the operating state of the wiper may also be switched from the continuous operating state to a stopped state in which the wiper is stopped. Also, when a vehicle door is opened while the wiper is in the intermittent operating state in which the wiper operates intermittently, the operating state of the wiper may be switched from this intermittent operating state to a stopped state in which the wiper is stopped. Moreover, when the vehicle door is opened while the wiper is in a first intermittent operating state in which the wiper operates intermittently, the operating state of the wiper may be switched from this first intermittent operating state to a second intermittent operating state in which the intermittent pause time is longer than it is in the first intermittent operating state.

According to this modified example, similar to the example embodiment described above, when a vehicle door is opened while the wiper is in a predetermined operating state, the state of the wiper is forcibly changed to a restricted operating state, and this restricted operating state of the wiper is then continued until a predetermined period of time has passed after the vehicle door is closed, so the vehicle interior check that is performed when the vehicle door is closed is able to be executed while the wiper is in an operating state that is more restricted than normal. Consequently, it is possible to inhibit this vehicle interior check from being impeded as a result of operation of the wiper.

1. A vehicle control system comprising:
a wiper, an operating state of which is selectively switched between a first operating state and a second operating state that is more restricted than the first operating state;
a wiper control portion that outputs a drive command such that the wiper is placed in the first operating state or the second operating state; and
a checking portion that checks whether a mobile device carried by a user of a vehicle is in the vehicle via wireless communication between an onboard device and the mobile device, when a door of the vehicle is opened or closed,
wherein if the door is opened while the wiper is in the first operating state, the wiper control portion performs a first switching control that switches the operating state of the wiper from the first operating state to the second operating state, and then after a period of time for which the check by the checking portion is executed has passed while the wiper is in the second operating state switched by the first switching control, performs a second switching control that switches the operating state of the wiper from the second operating state to the first operating state.

2. The vehicle control system according to claim 1, wherein
after the first switching control, the wiper control portion switches the operating state of the wiper from the second operating state to the first operating state when a predetermined period of time has passed after the door of the vehicle is closed.

3. The vehicle control system according to claim 2, wherein
the second operating state is a state in which the wiper operates intermittently; and
the predetermined period of time is set based on a period of time during which operation when the wiper that has been switched by the first switching control operates intermittently is stopped.

4. The vehicle control system according to claim 1, wherein
the first operating state is a state in which the wiper operates continuously; and
the second operating state is a state in which the wiper operates intermittently.

5. The vehicle control system according to claim 4, wherein
the state in which the wiper operates intermittently has a preset predetermined period of time during which operation of the wiper is stopped.

6. The vehicle control system according to claim 1, wherein
the first operating state is a state in which the wiper operates continuously; and
the second operating state is a state in which the wiper is stopped.

7. The vehicle control system according to claim 1, wherein
the first operating state is a state in which the wiper operates intermittently; and
the second operating state is a state in which the wiper is stopped.
